(19) United States
(12) Patent Application Publication
(10) Pub. No.: US 2015/0082006 A1
(43) Pub. Date: Mar. 19, 2015

(54) System and Method for an Asynchronous Processor with Asynchronous Instruction Fetch, Decode, and Issue

(71) Applicant: Futurewei Technologies, Inc., Plano, TX (US)

(72) Inventors: Yiqun Ge, Kanata (CA); Wuxian Shi, Kanata (CA); Qifan Zhang, Lachine (CA); Tao Huang, Kanata (CA); Wen Tong, Ottawa (CA)

(21) Appl. No.: 14/477,563

(22) Filed: Sep. 4, 2014

Related U.S. Application Data
(60) Provisional application No. 61/874,894, filed on Sep. 6, 2013.

(51) Int. Cl. G06F 9/30

(52) U.S. Cl. CPC G06F 9/30145; G06F 9/3005
USPC 712/208

(57) ABSTRACT

Embodiments are provided for an asynchronous processor with an asynchronous Instruction fetch, decode, and issue unit. The asynchronous processor comprises an execution unit for asynchronous execution of a plurality of instructions, and a fetch, decode and issue unit configured for asynchronous decoding of the instructions. The fetch, decode and issue unit comprises a plurality of resources supporting functions of the fetch, decode and issue unit, and a plurality of decoders arranged in a predefined order for passing a plurality of tokens. The tokens control access of the decoders to the resources and allow the decoders exclusive access to the resources. The fetch, decode and issue unit also comprises an issuer unit for issuing the instructions from the decoders to the execution unit

This application claims the benefit of U.S. Provisional Application No. 61/874,894 filed on Sep. 6, 2013 by Yiqun Ge et al. and entitled “Method and Apparatus for Asynchronous Processor with Asynchronous Instruction Fetch, Decode, and Issue,” which is hereby incorporated herein by reference as if reproduced in its entirety.

### TECHNICAL FIELD

The present invention relates to asynchronous processing, and, in particular embodiments, to system and method for an asynchronous processor with asynchronous instruction fetch, decode, and issue.

### BACKGROUND

Micropipeline is a basic component for asynchronous processor design. Important building blocks of the micropipeline include the RENDEZVOUS circuit such as, for example, a chain of Muller-C elements. A Muller-C element can allow data to be passed when the current computing logic stage is finished and the next computing logic stage is ready to start. Instead of using non-standard Muller-C elements to realize the handshaking protocol between two clockless (without using clock timing) computing circuit logics, the asynchronous processors replicate the whole processing block (including all computing logic stages) and use a series of tokens and token rings to simulate the pipeline. Each processing block contains a token processing logic to control the usage of tokens without time or clock synchronization between the computing logic stages. Thus, the processor design is referred to as an asynchronous or clockless processor design. The token ring regulates the access to system resources. The token processing logic accepts, holds, and passes tokens between each other in a sequential manner. When a token is held by a token processing logic, the block can be granted the exclusive access to a resource corresponding to that token, until the token is passed to a next token processing logic in the ring. There is a need for an improved and more efficient asynchronous processor architecture which is capable of processing instructions and computations with less latency or delay.

### SUMMARY OF THE INVENTION

In accordance with an embodiment, a method performed by an asynchronous processor includes receiving, at a decoder of a plurality of decoders in a token based fetch, decode, and issue unit of the asynchronous processor, a token enabling exclusive access to a corresponding resource for the token based fetch, decode and issue unit. The token is then held at the decoder, which accesses the corresponding resource. The decoder performs, using the corresponding resource, a function on an instruction received by the decoder, and upon completing the function, releases the token to other decoders.

In accordance with another embodiment, a method performed by a fetch, decode and issue unit in an asynchronous processor includes receiving a plurality of instructions at a plurality of corresponding decoders arranged in a predefined order. The method also includes receiving a plurality of tokens at the corresponding decoders, wherein the tokens allow the corresponding receiving decoders to exclusively access a plurality of corresponding decoding resources in the fetch, decode and issue unit and associated with the tokens. The decoders decode, independently from each other, the instructions using the corresponding decoding resources, and upon completing the decoding using the corresponding decoding resources, release the tokens.

In accordance with yet another embodiment, an apparatus for an asynchronous processor comprises an execution unit for asynchronous execution of a plurality of instructions, and a fetch, decode and issue unit configured for asynchronous decoding of the instructions. The fetch, decode and issue unit comprises a plurality of resources supporting functions of the fetch, decode and issue unit, and a plurality of decoders arranged in a predefined order for passing a plurality of tokens. The tokens control access of the decoders to the resources and allow the decoders exclusive access to the resources. The fetch, decode and issue unit also comprises an issuer unit for issuing the instructions from the decoders to the execution unit.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a Sutherland asynchronous micropipeline architecture;

FIG. 2 illustrates a token ring architecture;

FIG. 3 illustrates an asynchronous processor architecture;

FIG. 4 illustrates token based pipelining with gating within an arithmetic and logic unit (ALU);

FIG. 5 illustrates token based pipelining with passing between ALUs;

FIG. 6 illustrates a synchronous fetch, decoding, and issue unit;

FIG. 7 illustrates an embodiment of a token based fetch, decode, and issue unit architecture; and

FIG. 8 illustrates an embodiment of a token gating system for a token based fetch, decode, and issue unit;

FIG. 9 illustrates an embodiment of a token passing system for a token based fetch, decode, and issue unit;

FIG. 10 illustrates an embodiment of a method applying a token based fetch, decode, and issue unit.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

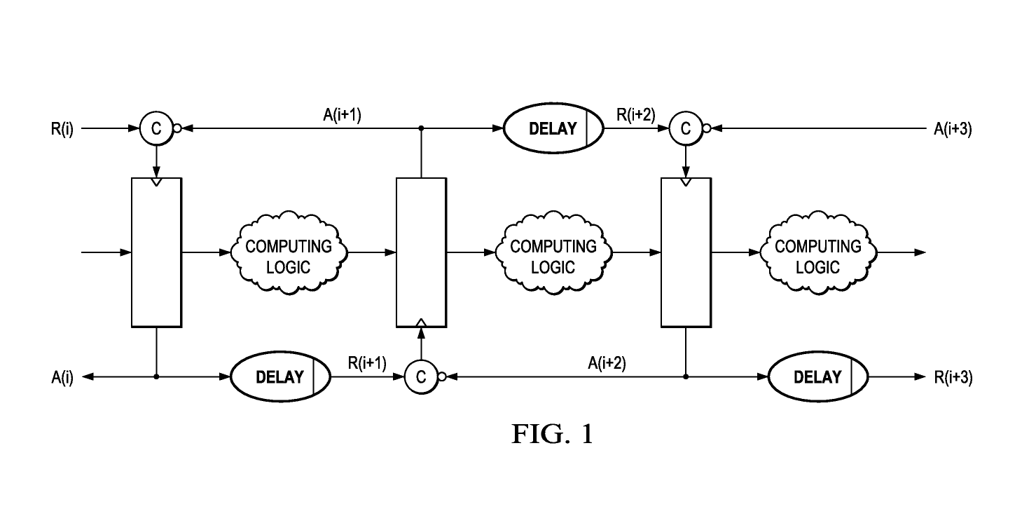

FIG. 1 illustrates a Sutherland asynchronous micropipeline architecture. The Sutherland asynchronous micropipeline architecture is one form of asynchronous micropipeline architecture that uses a handshaking protocol to operate the micropipeline building blocks. The Sutherland asynchronous micropipeline architecture includes a plurality of computing logics linked in sequence via flip-flops or latches. The computing logics are arranged in series and separated by the latches between each two adjacent computing logics. The handshaking protocol is realized by Muller-C elements (labeled C) to control the latches and thus determine whether and when to pass information between the computing logics. This allows for an asynchronous or clockless control of the pipeline without the need for timing signal. A Muller-C element has an output coupled to a respective latch and two inputs coupled to two other adjacent Muller-C elements, as shown. Each signal has one of two states (e.g., 1 and 0, or true and false). The input signals to the Muller-C elements are indicated by A(i), A(i+1), A(i+2), A(i+3) for the backward direction and R(i), R(i+1), R(i+2), R(i+3) for the forward direction, where i, i+1, i+2, i+3 indicate the respective stages in the series. The inputs in the forward direction to Muller-C elements are delayed signals, via delay logic stages The Muller-C element also has a memory that stores the state of its previous output signal to the respective latch. A Muller-C element sends the next output signal according to the input signals and the previous output signal. Specifically, if the two input signals, R and A, to the Muller-C element have different state, then the Muller-C element outputs A to the respective latch. Otherwise, the previous output state is held. The latch passes the signals between the two adjacent computing logics according to the output signal of the respective Muller-C element. The latch has a memory of the last output signal state. If there is state change in the current output signal to the latch, then the latch allows the information (e.g., one or more processed bits) to pass from the preceding computing logic to the next logic. If there is no change in the state, then the latch blocks the information from passing. This Muller-C element is a non-standard chip component that is not typically supported in function libraries provided by manufacturers for supporting various chip components and logics. Therefore, implementing on a chip the function of the architecture above based on the non-standard Muller-C elements is challenging and not desirable.

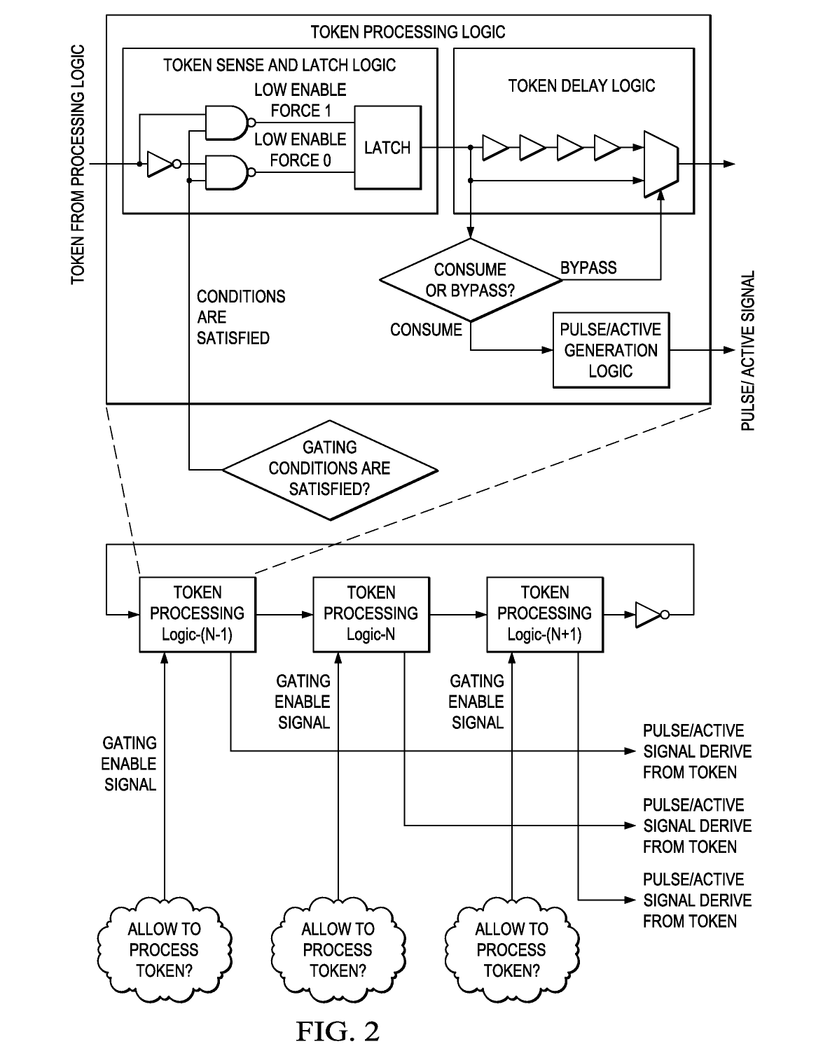

FIG. 2 illustrates an example of a token ring architecture which is a suitable alternative to the architecture above in terms of chip implementation. The components of this architecture are supported by standard function libraries for chip implementation. As described above, the Sutherland asynchronous micropipeline architecture requires the handshaking protocol, which is realized by the non-standard Muller-C elements. In order to avoid using Muller-C elements (as in FIG. 1), a series of token processing logics are used to control the processing of different computing logics (not shown), such as processing units on a chip (e.g., ALUs) or other functional calculation units, or the access of the computing logics to system resources, such as registers or memory. To cover the long latency of some computing logics, the token processing logic is replicated to several copies and arranged in a series of token processing logics, as shown. Each token processing logic in the series controls the passing of one or more token signals (associated with one or more resources). A token signal passing through the token processing logics in series forms a token ring. The token ring regulates the access of the computing logics (not shown) to the system resource (e.g., memory, register) associated with that token signal. The token processing logics accept, hold, and pass the token signal between each other in a sequential manner. When a token signal is held by a token processing logic, the computing logic associated with that token processing logic is granted the exclusive access to the resource corresponding to that token signal, until the token signal is passed to a next token processing logic in the ring. Holding and passing the token signal concludes the logic's access or use of the corresponding resource, and is referred to herein as consuming the token. Once the token is consumed, it is released by this logic to a subsequent logic in the ring.

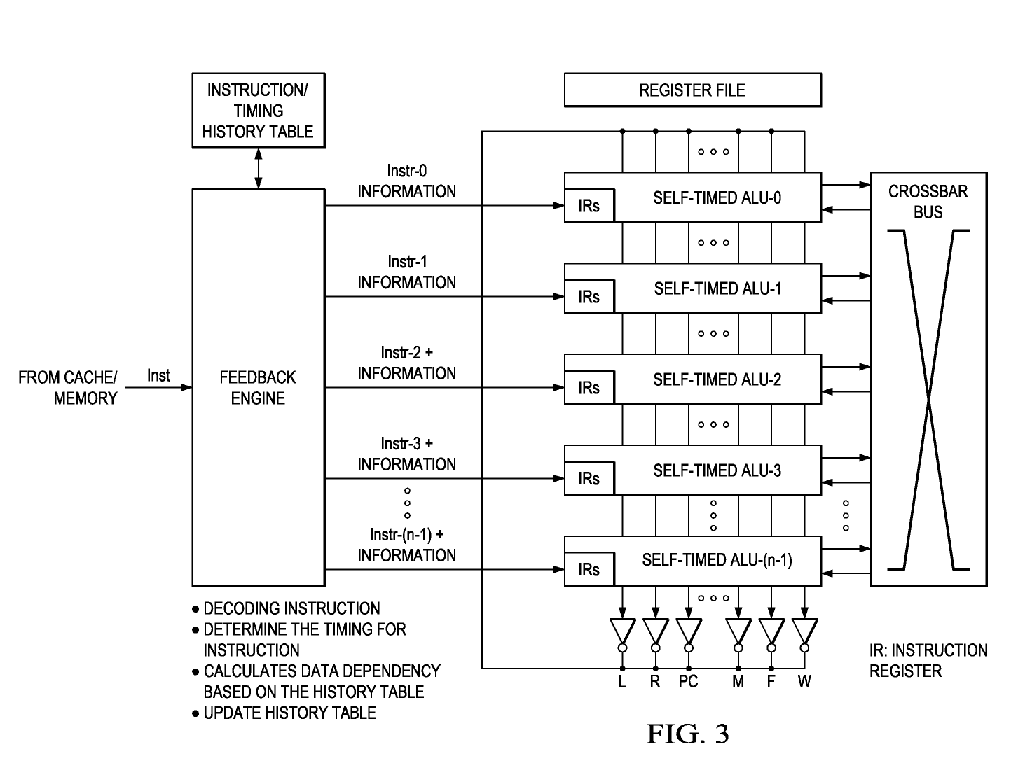

FIG. 3 illustrates an asynchronous processor architecture. The architecture includes a plurality of self-timed (asynchronous) arithmetic and logic units (ALUs) coupled in parallel in a token ring architecture as described above. The ALUs can comprise or correspond to the token processing logics of FIG. 2. The asynchronous processor architecture of FIG. 3 also includes a feedback engine for properly distributing incoming instructions between the ALUs, an instruction/timing history table accessible by the feedback engine for determining the distribution of instructions, a register (memory) accessible by the ALUs, and a crossbar for exchanging needed information between the ALUs. The table is used for indicating timing and dependency information between multiple input instructions to the processor system. The instructions from the instruction cache/memory go through the feedback engine which detects or calculates the data dependencies and determines the timing for instructions using the history table. The feedback engine pre-decodes each instruction to decide how many input operands this instruction requires. The feedback engine then looks up the history table to find whether this piece of data is on the crossbar or on the register file. If the data is found on the crossbar bus, the feedback engine calculates which ALU produces the data. This information is tagged to the instruction dispatched to the ALUs. The feedback engine also updates accordingly the history table.

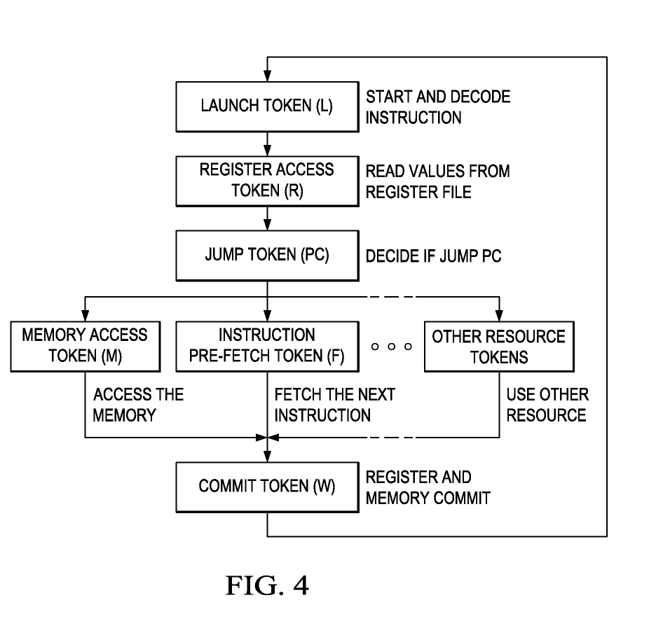

FIG. 4 illustrates token based pipelining with gating within an ALU, also referred to herein as token based pipelining for an intra-ALU token gating system. According to this pipelining, designated tokens are used to gate other designated tokens in a given order of the pipeline. This means when a designated token passes through an ALU, a second designated token is then allowed to be processed and passed by the same ALU in the token ring architecture. In other words, releasing one token by the ALU becomes a condition to consume (process) another token in that ALU in that given order. FIG. 4 illustrates one possible example of token-gating relationship. The tokens used include a launch token (L), a register access token®, a jump token (PC), a memory access token (M), an instruction pre-fetch token (F), optionally other resource tokens, and a commit token (W). Consuming (processing) the L token enables the ALU to start and decode an instruction. Consuming the R token enables the ALU to read values from a register file. Consuming the PC token enables the ALU to decide whether a jump to another instruction is needed in accordance with a program counter (PC). Consuming the M token enables the ALU to access a memory that caches instructions. Consuming the F token enables the ALU to fetch the next instruction from memory. Consuming other resources tokens enables the ALU to use or access such resources. Consuming the W token enables the ALU to write or commit the processing and calculation results for instructions to the memory. Specifically, in this example, the launch token (L) gates the register access token (R), which in turn gates the jump token (PC token). The jump token gates the memory access token (M), the instruction pre-fetch token (F), and possibly other resource tokens that may be used. This means that tokens M, F, and other resource tokens can only be consumed by the ALU after passing the jump token. These tokens gate the commit token (W) to register or memory. The commit token is also referred to herein as a token for writing the instruction. The commit token in turn gates the lunch token. The gating signal from the gating token (a token in the pipeline) is used as input into a consumption condition logic of the gated token (the token in the next order of the pipeline). For example, the launch-token (L) generates an active signal to the register access or read token (R), when L is released to the next ALU. This guarantees that any ALU would not read the register file until an instruction is actually started by the launch-token.

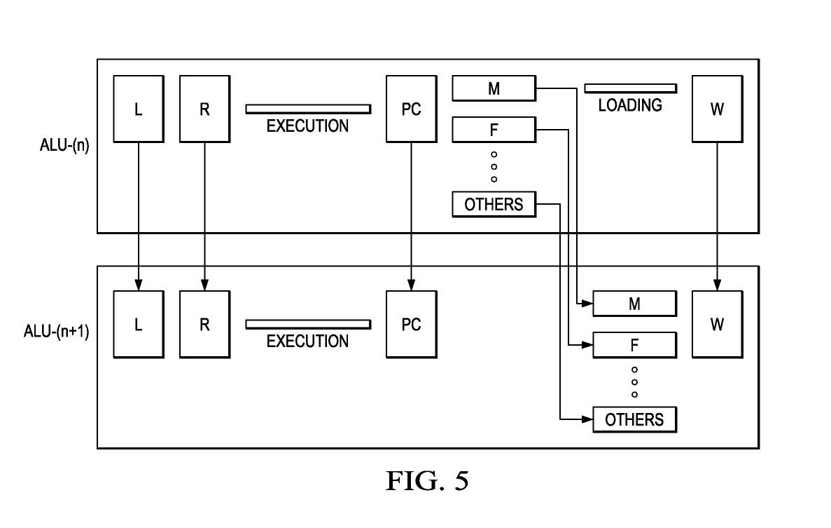

FIG. 5 illustrates token based pipelining with passing between ALUs, also referred to herein as token based pipelining for an inter-ALU token passing system. According to this pipelining, a consumed token signal can trigger a pulse to a common resource. For example, the register-access token (R) triggers a pulse to the register file. The token signal is delayed before it is released to the next ALU for such a period, preventing a structural hazard on this common resource (the register file) between ALU-(n) and ALU-(n+1). The tokens preserve multiple ALUs from launching and committing (or writing) instructions in the program counter order, and also avoid structural hazard among the multiple ALUs.

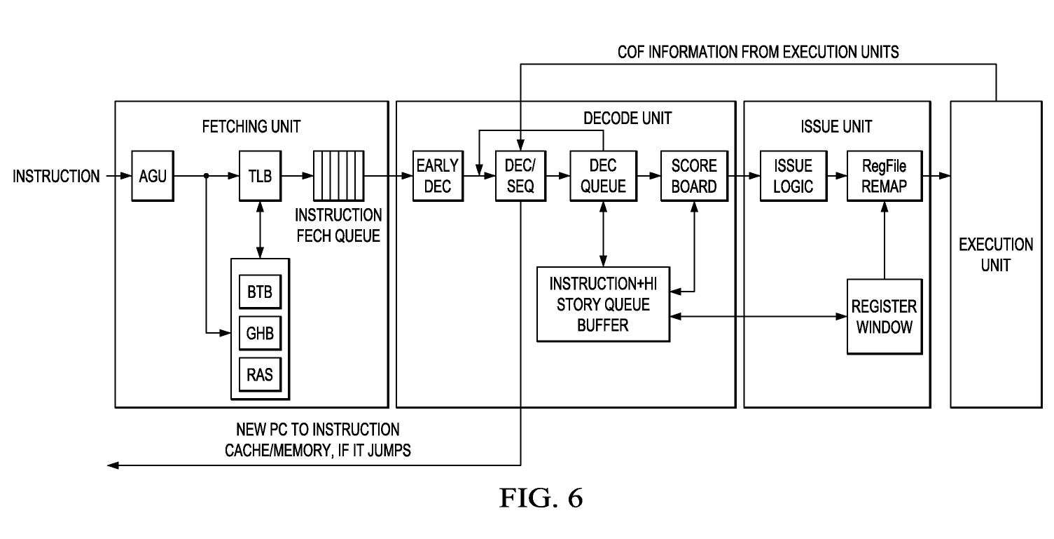

FIG. 6 illustrates a synchronous fetch, decoding, and issue unit, which is typically used in an asynchronous processor architecture. A typical fetch/decode/issue unit comprises a fetch function or logic, a decode function, and an issue function. The functions can be implemented by suitable circuit logic. The fetch function fetches the instructions from cache/memory, performs branch/jump predication, stacks the return instruction addresses, and calculates and checks the effective instruction addresses. The decode function decodes the instructions, processes change-of-flow (COF) reports for the instructions, buffers the instructions, and scoreboards the instructions. The issue function remaps the operands of the instructions, and dispatches the instructions to the ALUs. The synchronous fetch, decoding, and issue unit of FIG. 6 corresponds to the feedback engine in FIG. 3. The synchronous fetch, decoding, and issue unit distributes and sends the instructions to the ALUs of the asynchronous processor. The ALUs are arranged in a token ring architecture as shown in FIG. 3.

In the above asynchronous design of the fetch/decode/issue unit, the number of fetch/decode/issue stages occupies a substantial portion of a total length of the instruction processing pipeline in the asynchronous processor. The pipeline can even become longer for some processor designs, which increases delays such as the pipeline flush penalty in case of prediction and decision branching. It is desirable that the pipeline be easily expandable. For example, many operations are expected to be done at this stage. Further, newer operations may be added.

The system and method embodiments herein are described in the context of an ALU set in the asynchronous processor. The ALUs serve as instruction processing units that perform calculations and provide results for the corresponding issued instructions. However in other embodiments, the processor may comprise other instruction processing units instead of the ALUs. The instruction units may be referred to sometimes as execution units (XUs) or execution logics, and may have similar, different or additional functions for handling instructions than the ALUs described above. In general, the system and method embodiments described herein can apply to any instruction execution or processing units that operate, in an asynchronous processor architecture, using a token based fetch, decode, and issue unit and its token gating and passing systems described below.

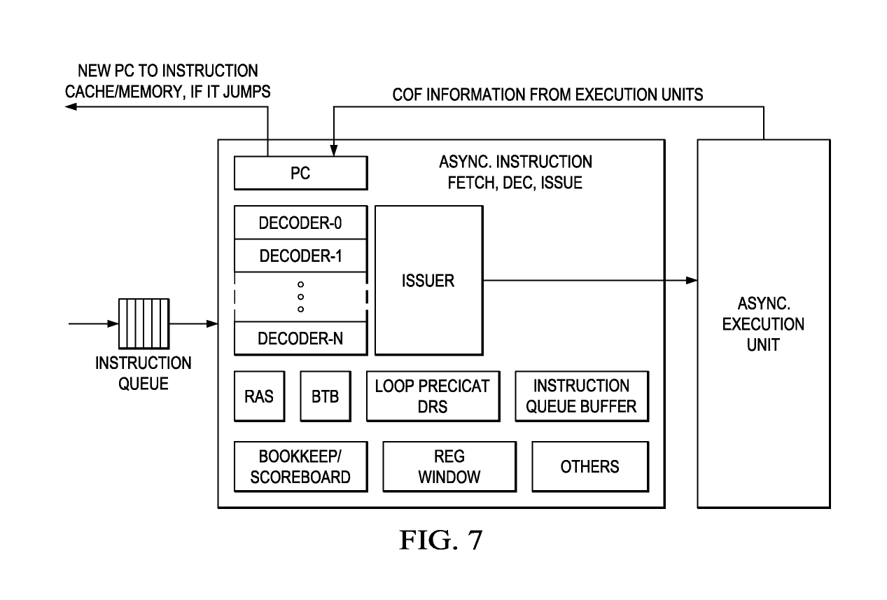

FIG. 7 illustrates an embodiment of a token based fetch, decode, and issue unit architecture that overcomes the disadvantages of the typical fetch, decode, and issue unit and meets the requirements above. Specifically, the architecture establishes an asynchronous fetch/decode/issue unit by a token system, where different resources are accessed and controlled in an asynchronous manner to handle multiple instructions at about the same time using the token system. The architecture includes a plurality of decoders (decoder-0 to decoder-N) that decodes instructions asynchronously (separately or substantially in an independent manner). The incoming instructions can be queued before sending the instructions to the appropriate decoders. The architecture also includes a plurality of processing resources that can be accessed by the decoders for supporting the handling and decoding of the instructions. The resources may include a branch prediction table (BTB), a return address stack (RAS), a registry window, a bookkeep/scoreboard, loop predicators, an instruction queue buffer, an issuer for issuing the decoded instructions properly to corresponding ALUs or any suitable type of XUs, a program counter (PC) for controlling instructions jumps, according to COF information from the execution unit, and optionally other resources. The description of the functionalities of the decoders and their resources are shown in Table 1 below. The functions can be implemented by any suitable circuit logic.

TABLE 1
Resources of the token based fetch, decode, and issue unit

| Functionality | Description |
|---|---|
| Decoder | Early decode instruction to decide the type of instruction (jump, call, |
| | return, other) |
| BTB | Branch-predication-table, e.g., bimodal predictor, global-history-table- |
| | based predictor, or other prediction algorithms |
| RAS | Return-address-stack, when entry into a function, stack in the PC |
| | address; when return from a function, stack out the PC address |
| Register window | When entry or return a function, update the register window; for other |
| | instructions de-map (remove mapping of) the operands |
| Bookkeep/scoreboard | Detect data hazard and calculate data dependency, log the data |
| | dependency information, decide if an instruction is ready for issue |
| | (scoreboard) |
| Loop predicators | If the loop counter is given by an immediate value of an instruction, |
| | predict loops, support nested loops |
| Instruction queue | Every issued instruction is registered into this buffer |
| buffer | |
| Issuer | Issue the instruction to the execution unit (the set of XUs, e.g., ALUs); |
| | can actively push the instructions or passively wait for a request |
| PC | Monitor the COF requests from the execution unit; the request can be a |
| | branch PC jump or an exception/interruption |
| Others | Any other functionalities at the fetch/decode/issue stages, e.g., address |
| | generation unit (AGU), access to address register, or access to special |
| | register |

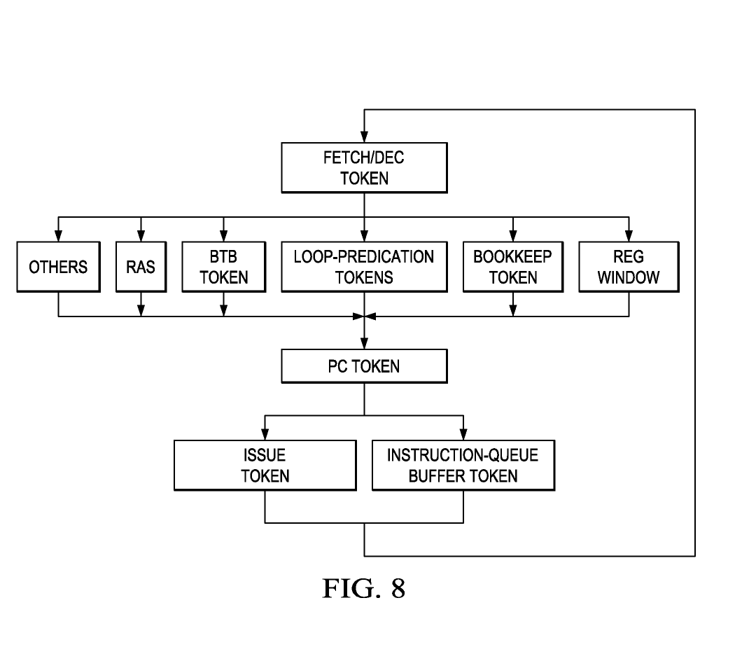

The decoders' exclusive access to the various resources is controlled using a token system. Specifically, a decoder is granted the exclusive access to a resource by holding and then releasing that token to another decoder. The tokens are gated and passed by the decoders according to a defined token pipelining (defined order of tokens). FIG. 8 illustrates an embodiment of a token gating system for the token based fetch, decode, and issue unit, in the asynchronous processor architecture. This intra-decoder token gating system can form a cascade of the instruction fetch, decode, and issue stages. The token gating follows a similar principle as that described for the token based pipelining with gating in FIG. 4. Specifically, in FIG. 8, designated tokens are used to gate other designated tokens in a given order of the pipeline. This means when a designated token passes through a decoder of the fetch, decode, and issue unit, a second designated token is then allowed to be processed and passed by the same decoder. In other words, releasing one token by the decoder becomes a condition to consume (process) another token in that decoder in that given order. The tokens can be passed according to the order of the arrangement of the decoders (a defined order) in the fetch, decode and issue unit. In an embodiment, the decoders are arranged in a ring architecture similar to that of the ALUs in FIG. 3. FIG. 8 illustrates one possible example of token-gating relationship. The tokens used include a fetch and decode token, a RAS token, A BTB token, a loop predication token, a bookkeep token, a register (Reg) token, one or more other resources (others) tokens, a PC token, an issuer token, and an instruction-queue buffer token.

Consuming (processing) the fetch and decode token enables the decoder to fetch and decode an instruction. Consuming the RAS, BTB, loop predication, bookkeep, register window, and other resource token(s) enables the decoder to exclusively access such resources without the other decoders. Consuming the PC token enables the decoder to decide whether a jump to another instruction is needed in accordance with a program counter (PC). Consuming the issuer token enables the decoder to send the instruction to the issuer which then issues the instruction to an XU. Consuming the instruction-queue buffer token enables the decoder to access the instruction-queue buffer. Specifically, in this embodiment, the fetch and decode token gates the RAS, BTB, loop predication, bookkeep, register window, and other resource token(s). These resource tokens gate, in turn, the PC token. The PC token gates the issuer token and the instruction-queue buffer token, which both gate the fetch and decode token. For example, the fetch and decode token generates an active signal to the register window token, when the fetch and decode token is released to another decoder. This guarantees that any decoder would not update the register window until an instruction is actually fetched and decoded.

The based fetch, decode, and issue unit architecture and its token gating system above is one embodiment or example of implementation. A practical realization may be different but follows a similar principle to a token based system. For instance, in practical cases where there are other function(s) to be executed at this stage, a resource/functional block is inserted to this architecture. A token is created to indicate the decoder's exclusive access to the added resource/functional block. The token is integrated into the token-system (gate a pass) as described above.

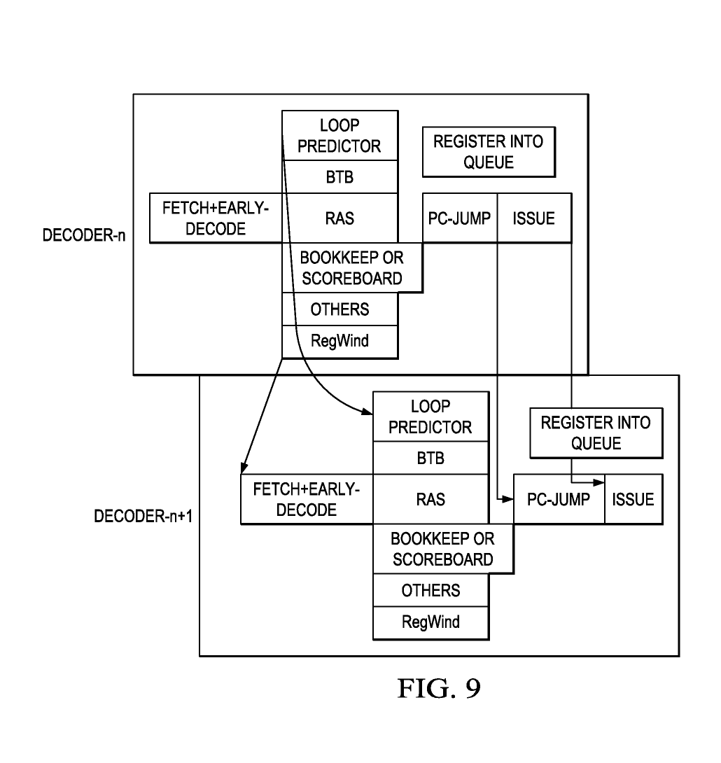

FIG. 9 illustrates an embodiment of a token passing system for a token based fetch, decode, and issue unit. The system can be implemented between the multiple decoders in the asynchronous (token based) fetch, decode and issue unit. This inter-decoder token passing system preserves the program counter (PC) order, and avoids the structural hazard, e.g., resource conflicts among multiple decoders.

According to this pipelining system, a consumed token signal can trigger a pulse to a common resource for the decoders. For example, the PC token triggers the monitoring of the COF requests (e.g., branch PC jump or an exception/interruption requests) from the execution unit. The token signal is delayed before it is released to the next decoder for such a period, preventing a structural hazard on this common resource between Decoder-n and Decoder-n+1. The tokens ensure that multiple decoders to decode and issue instructions in the program counter order, and also avoid structural hazard among the multiple decoders.

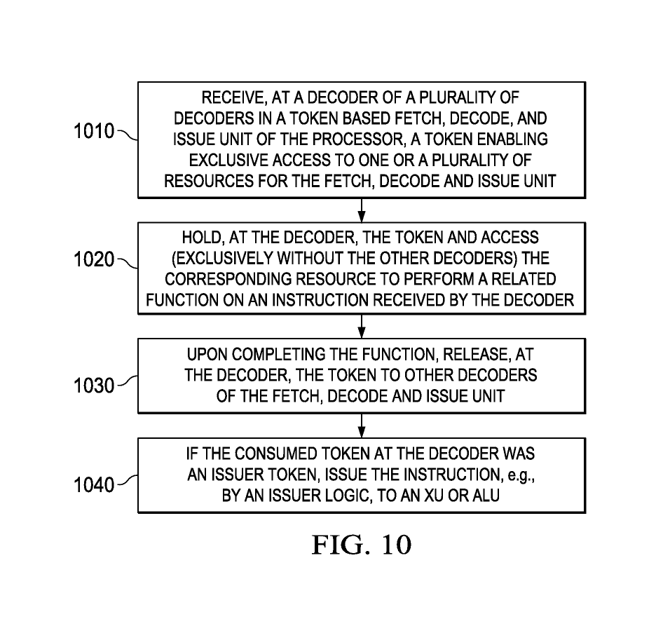

FIG. 10 illustrates an embodiment of a method applying an asynchronous (token based) fetch, decode, and issue unit architecture. At step 1010, a decoder of a plurality of decoders in a token based fetch, decode, and issue unit of the processor receives a token enabling exclusive access to one or a plurality of resources for the fetch, decode and issue unit. For instance, the token is one of the tokens of the token based fetch, decode, and issue unit architecture described above. At step 1020, the decoder holds the token and accesses (exclusively without the other decoders) the corresponding resource to perform a related function on an instruction received by the decoder. At step 1030, upon completing the function, the decoder releases the token to the other decoders of the fetch, decode and issue unit. At step 1040, if the consumed token at the decoder was an issuer token, the instruction is issued, e.g., by an issuer logic, to an XU or ALU. The method enables the decoders to operate on and decode the instructions in an asynchronous manner. For example, multiple decoders can fetch multiple instructions but access different resources at the same time period.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by an asynchronous processor, the method comprising:
receiving, at a decoder in a plurality of decoders in a token based fetch, decode, and issue unit of the asynchronous processor, a token enabling exclusive access to a corresponding resource for the token based fetch, decode and issue unit;
holding the token at the decoder;
accessing the corresponding resource;
performing, using the corresponding resource, a function on an instruction received by the decoder; and
upon completing the function, releasing, at the decoder, the token to other decoders.

2. The method of claim 1, wherein the corresponding resource is accessed exclusively by the decoder without the other decoders, until the releasing of the token by the decoder.

3. The method of claim 1, wherein the token is an issuer token for issuing the instruction from the token based fetch, decode and issue unit to an execution unit of the asynchronous processor, and wherein the method further comprises issuing the instruction to the execution unit.

4. The method of claim 1 further comprising:
after releasing the token, receiving at the decoder a second token enabling exclusive access to a second resource for the token based fetch, decode an disuse unit;
holding the second token at the decoder; and
accessing the second resource;
performing, using the second resource, a second function on the instruction or a second instruction received by the decoder; and
upon completing the second function, releasing, at the decoder, the second token to other decoders.

5. The method of claim 1, wherein the token is one of a plurality of tokens received by the decoders for accessing corresponding resources in accordance with a predefined order of token pipelining and token-gating relationship.

6. The method of claim 5 further comprising passing, in accordance with the predefined order of token pipelining and token-gating relationship, the tokens from the decoder to a next decoder in an arranged order of the decoders in the token based fetch, decode and issue unit.

7. The method of claim 5, wherein the resources include at least one of a return address stack (RAS), a branch prediction table (BTB), a registry window, a bookkeep or scoreboard, a loop predicator, an instruction-queue buffer, an issuer for issuing instructions to an execution unit, and a program counter (PC) unit for deciding whether a jump for handling an instruction is needed in accordance with a PC.

8. The method of claim 7, wherein, in accordance with the predefined order of token pipelining and token-gating relationship, releasing a token for fetching a decoding an instruction is a condition to receive resource tokens for accessing and using the RAS, the BTB, the registry window, the bookkeep or scoreboard, the loop predicator, wherein releasing the resource tokens is a condition to receive a token for PC jumps, and wherein releasing the token for PC jumps is a condition to receive a token for using the instruction and a token for accessing and using and instruction-queue buffer.

9. A method performed by a fetch, decode and issue unit in an asynchronous processor, the method comprising:
receiving a plurality of instructions at a plurality of corresponding decoders arranged in a predefined order;
receiving a plurality of tokens at the corresponding decoders, wherein the tokens allow the corresponding receiving decoders to exclusively access a plurality of corresponding decoding resources in the fetch, decode and issue unit and associated with the tokens;
decoding, at the decoders independently from each other, the instructions using the corresponding decoding resources; and
upon completing the decoding using the corresponding decoding resources, releasing the tokens at the decoders.

10. The method of claim 9, wherein the released tokens are available to be received and used by the other decoders to exclusively access the corresponding decoding resources associated with the tokens.

11. The method of claim 9, wherein the tokens are received in accordance with a predefined order of token pipelining and token-gating relationship.

12. The method of claim 11 further comprising passing, in accordance with the predefined order of token pipelining and token-gating relationship, the tokens between the decoders in an arranged order of the decoders.

13. The method of claim 9, wherein the decoding resources include at least one of a return address stack (RAS), a branch prediction table (BTB), a registry window, a bookkeep or scoreboard, a loop predicator, an instruction-queue buffer, an issuer for issuing instructions to an execution unit, and a program counter (PC) unit for deciding whether a jump for handling an instruction is needed in accordance with a PC.

14. An apparatus for an asynchronous processor comprising:
an execution unit for asynchronous execution of a plurality of instructions; and
a fetch, decode and issue unit configured for asynchronous decoding of the instructions and comprising:
a plurality of resources supporting functions of the fetch, decode and issue unit;
a plurality of decoders arranged in a predefined order for passing a plurality of tokens, wherein the tokens control access of the decoders to the resources and allow the decoders exclusive access to the resources; and
an issuer unit for issuing the instructions from the decoders to the execution unit.

15. The apparatus of claim 14, wherein fetch decode and issue unit further comprises a program counter (PC) unit configured to decide whether a jump for handling a new instruction is needed in accordance with a program counter (PC) and further in accordance with change-of-flow (COF) information from the execution unit.

16. The apparatus of claim 15, wherein resources include at least one of a return address stack (RAS), a branch prediction table (BTB), a registry window, a bookkeep or scoreboard, a loop predicator, and an instruction-queue buffer.

17. The apparatus of claim 16, wherein the decoders are further configured to receive the tokens in accordance with a predefined order of token pipelining and token-gating relationship.

18. The apparatus of claim 17, wherein, in accordance with the predefined order of token pipelining and token-gating relationship, releasing a token for fetching a decoding an instruction is a condition to receive resource tokens for accessing and using the RAS, the BTB, the registry window, the bookkeep or scoreboard, the loop predicator, wherein releasing the resource tokens is a condition to receive a token for PC jumps, and wherein releasing the token for PC jumps is a condition to receive a token for using the instruction and a token for accessing and using and instruction-queue buffer.

19. The apparatus of claim 14, wherein the execution unit comprises a plurality of arithmetic and logic units (ALUs) arranged in a ring architecture for passing a plurality of second tokens, and wherein the second tokens control access of the ALUs to a plurality of corresponding second resources for the execution unit.

20. The apparatus of claim 14, wherein the resources, decoders, and the issuer are configured via circuit logic.
